(19) United States
(12) Patent Application Publication
(10) Pub. No.: US 2005/0086132 A1
(43) Pub. Date: Apr. 21, 2005

(54) System and method for site-specific electronic record keeping

(76) Inventors: William A. Kanitz, Sarasota, FL (US); Lawrence E. Olson, Sarasota, FL (US)

Correspondence Address: Paul F. Swift;McCarter & English, LLP, Four Gateway Center, 100 Mulberry Street, Newark, NJ, 07102, US

(21) Appl. No.: 10/688,528

(22) Filed: Oct. 21, 2003

Related U.S. Application Data
(60) Provisional application No. 60/495,665, filed on Aug. 15, 2003.

(51) Int. Cl. G06F 17/60

(52) U.S. Cl. 705/28

(57) ABSTRACT

A tracking and labeling system for collecting, recording and reporting data on an item as the item experiences changes in state over time. The system has a plurality of node systems connected to the Internet that transmit data to a server with database handling software. As the item is processed at various places and times, the data associated with the item is captured by the node systems and sent to the server database. At various points along the way, labels may be generated to hold a selected portion of the data associated with the item. The labels may be read by offline apparatus, as well as by the node systems. The node systems may also print labels, e.g., in 2D matrix format, for updating the data associated with an item as it is processed. In this manner, the label contains up-to-date information on the item. The system permits the entire chronologically ordered site-specific history of an item to be recalled through a query directed to the server system and therefore can be applied to various applications such as tracking the origin of food products for public health purposes. The server system can be accessed by users on the Internet.

### CROSS-REFERENCES TO RELATED APPLICATIONS

This is a continuation in part of Provisional Application No. ______ (to be assigned) entitled, Matrix Barcode Tracking System, filed Aug. 15, 2003.

### FIELD OF THE INVENTION

This invention relates generally to electronic record keeping and product labeling systems and in particular to a record keeping and labeling system and associated methods for providing global record keeping capabilities for tracking and labeling livestock, produce, wine, food products, manufactured goods and virtually any object or collection of objects as they move from place to place over time in the course of production, transportation, processing, marketing and use.

### BACKGROUND OF THE INVENTION

Tracking the movement and state (condition) of commodities is an increasingly vital function in today's global marketplace. In some cases, public health and safety depends on the ability of investigators to trace the history of a particular commodity. In a recent example, a case of bovine spongiform encephalopathy (BSE), commonly known as mad cow disease, surfaced in Alberta, Canada. Consequently, it was necessary for officials to research the background of the diseased cow, the herd it originally came from, the farm where it lived, the plant that rendered the carcass, and the site that received the rendered product. In that case, it took investigators more than a week to determine where the cow was bred and raised on farms in Alberta and Saskatchewan. DNA testing was utilized in making the determination. In the meantime, news of the disease caused the United States and other countries to shut their borders to Canadian beef exports, causing Canadian cattle ranchers to lose tens of millions of dollars a day. Had investigators had quicker access to a verifiable record of the background of the diseased cow, significant financial damage might have been mitigated.

The Farm Security and Rural Investment Act of 2002, more commonly known as the 2002 Farm Bill, signed into law on May 13, 2002 by President Bush, provides another example of the increasing significance of record keeping and tracking of commodities. One of the law's many initiatives requires country of origin labeling for beef, lamb, pork, fish, perishable agricultural commodities and peanuts. The United States Department of Agriculture (USDA) has responsibility for implementing the COOL (Country of Origin Labeling) program. The COOL program requires suppliers to provide country of origin information to retailers, including the “born, raised, and slaughtered” information required to make U.S. origin claims for the covered commodities beef, pork, and lamb. To verify products are properly labeled at the retail level, records must be maintained from an animal's birth to retail. The records needed to substantiate this information can be created only by record-keepers having first-hand knowledge of each production step for the commodity. In many cases, these production steps take place in a series of geographically separated locations. Furthermore, the production steps are typically carried out by different entities in the production chain. This requires record-keepers situated in diverse areas of the industry to keep records for the commodity.

In addition to the concerns outlined above, the threat of bio terrorism is causing government authorities to demand more information about where food comes from and how and when it's transported to market. Other health concerns are prompting an increasing number of people in the United States and other parts of the world to demand information about whether the meat they purchase has been treated with growth hormones or antibiotics. There is a growing consumer interest in whether vegetables are grown organically and whether grain has been genetically modified.

Therefore, a need exists for a centralized record-keeping and commodity tracking system and method applicable to domestic and international crops, animals and food products that can create a verifiable audit trail wherein interested persons, such as consumers and government officials, can trace the origins of beef, poultry, fish, fruit, vegetables, dairy, grain and the like the world over. Further, a need exists for an easy to use, inexpensive record-keeping system that can record and track the entire history of a commodity quickly and cost effectively.

Besides simple identification of origin, there are various other items of information that would be desirable to record about a commodity or other entity, object or item of interest over time. For example, the condition or quality of an item or its performance characteristics and statistics, e.g., in the case of a racehorse, would be beneficial to record and have convenient access to over the lifespan of the animal. Such record keeping would promote evaluation of the animal with similar animals in a standardized, meaningful way.

Product labeling has been used in the past to record and communicate product information and history, e.g., content, source, country of origin. Labeling is frequently in written language and very commonly in computer-readable form, such as bar codes. UPC (Universal Product Code) symbology has been used for decades to identify individual objects in numerous applications. This technology has given rise to a class of variants of linear coding to represent strings of numeric data, since the UPC symbol's length limits the amount of information that can be coded.

Another class of 2D (two-dimensional) symbology is being applied in situations where more data storage in more compact form is required. This symbology has the capability of storing long strings of alphanumeric data in very small areas by using data compression and compacting, and various coding techniques. While such labels are a relatively cheap and effective vehicle for recording and disclosing data about a commodity, the data presented on a label is static (fixed in content for presentation at a particular point in the labeled object's life cycle),

### SUMMARY OF THE INVENTION

The limitations of prior art commodity tracking and labeling systems are addressed by the present invention, which includes a system for collecting and recording data on an item as the item experiences changes in state over time. The system has a first data input device for capturing a first set of data pertaining to a first state of the item in a first environment. A second data input device captures a second set of data pertaining to a second state of the item in a second environment. The system has a data processor for storing the first and second sets of data in a database. A communications link is used to transmit the first and second sets of data to the data processor. In accordance with an associated method, a first set of data pertaining to an item in a first state in a first environment is collected and recorded. When the item changes from the first state and/or the first environment, to a second state and/or a second environment, a second set of data pertaining to the item is collected and recorded. The first and second sets of data are communicated to a data processing system where they are stored in a database. The first and second sets of data in the database are selectively accessed as desired by a user of the system.

### BRIEF DESCRIPTION OF THE DRAWINGS

FIG. 1 is a conceptual diagram of a tracking and labeling system in accordance with a first embodiment of the present invention.

FIG. 2 is a block diagram illustrating the relationship of various components of a local, node data processing system according to a first embodiment of the invention.

FIG. 3 is an exemplary 2D matrix bar code that may be used in conjunction with the system of FIGS. 1 and 2.

FIG. 4 is a block diagram showing a plurality of local data processing systems according to an embodiment of the invention.

FIG. 5 is one form of an exemplary data input/output screen according to an embodiment of the invention.

### DETAILED DESCRIPTION OF THE INVENTION

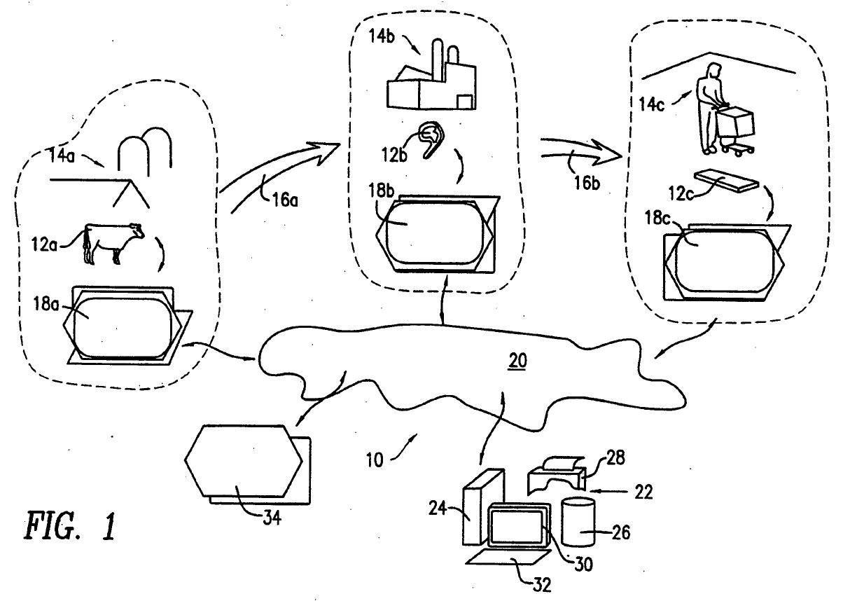

FIG. 1 shows a tracking and labeling system 10 for recording and reporting data about a commodity 12a, article or group of articles as it changes location and/or state (condition) over time. As shown, a commodity, such as a steer 12a may come into existence in a first environment, viz., a farm 14a where it is born and raised. The steer 12a may be sold and shipped to a meat processing plant 14b at another location where it is butchered and processed into meat products 12b (e.g., sides of beef or other large cuts of meat). The meat products 12b may then be shipped to a retail store 14c, for further processing and packaging into retail packages of meat 12c. The transition from one state, e.g., 12a associated with one environment 14a to another state 12b, in another environment 14b, is depicted by arrows 16a, 16b, which can represent physical transportation, the passage of time or a further processing step within the same general location and closely following in time. At each point in this sequence of events, data concerning the commodity 12a, 12b, and 12c may be noted and recorded by local (node) data capture and processing systems 18a, 18b, 18c, hereinafter referred to as “node systems.” Each node system 18a-18c may have different components for gathering data, transmitting, storing and sharing the data and generating outputs, such as labels, as shall be described more fully below. The node systems 18a, 18b, 18c are preferably connected to a network 20, such as the Internet, so that the data collected may be shared, processed, e.g., to constitute a searchable data base and stored via a server system 22 having a data processor 24 (a computer programmed with data processing/database software), non-volatile data storage 26 and conventional output 28, 30 and input 32 devices, by which the server 22 is maintained and the data collected by the server 22 is viewed and otherwise used. One or more subscriber systems 34 may use the network to obtain data from the server 22 and/or node systems 18a-18c. While the Internet has been identified as a suitable network 20, other suitable communications networks would include: cellular, satellite, Intranets, WANs, cable and fiber optic networks.

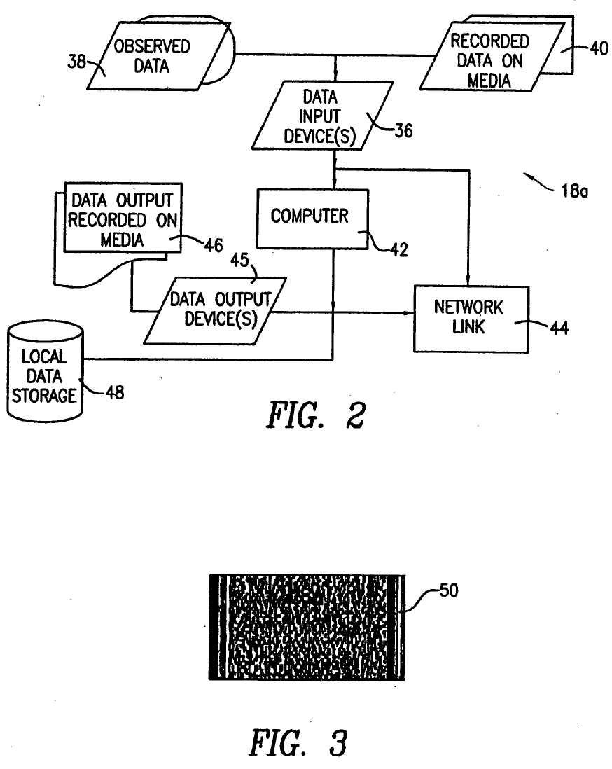

FIG. 2 shows a node system 18a for recording and sharing data concerning a commodity or article, e.g., 14a. Typically, the node system 18a would include at least one data input device 36, e.g., a bar code reader and/or keyboard, for receiving observed data 38 and/or data that was previously recorded on media 40, e.g., a bar code, such data previously recorded on media 40 being physically associated with the article 14a. A computer 42, e.g., in the form of a PC or handheld may be used to receive the data 38, 40 for transmission to the network 20, via a network link 44, such as a modem. If the data input device 36 is a PDA or cell phone, then a computer 42 may or may not be necessary, since such devices now have the capability to connect directly to the Internet 20, via radio transmission. The computer 42 may produce data output recorded on media 46, such as a 2D matrix label, bar code or data stick and/or record the data in local data storage 48. Because commodities, 12a, 12b, 12c and environments, e.g. 14a, 14b, 14c vary widely, each node system 18a, 18b, 18c may be similarly varied as to hardware and software components, as well as in functionality. For example, in the farm environment 14a depicted in FIG. 1, a steer 12a that is ready for market has many attributes of interest, such as age, breed, weight, source, appearance, veterinary record, feed history, etc. These attributes may be purely observed data 38 or may have been previously recorded data 40, recorded on some media, such as an Electronic Identification Tag (EID) tag, bar code or 2D matrix label. In the farm environment 14a, a steer 12a would typically have an EID tag fastened to it at birth or soon after. The EID tag would record owner information, birth date, breed, identification number, etc. A node system 18a in the cattle breeding farm environment 14a may include an EID tag reader as one of the data input devices 36. The data “written” on the EID tag would be an example of recorded data on media 40.

Continuing with this example, in addition to the recorded data on media 40, it would be expected that additional new data, i.e., observed data 38 such as current weight, health, age, etc. would be of interest to the overall process of tracking and describing the steer 12a in the farm environment 14a. The additional observed data, 38 can be captured and recorded by various additional data input devices 36. The age of the animal may be manually entered by a keyboard, the weight of the animal may be ascertained by weighing the animal on a conventional scale and keying in the results, or directly inputting digital weight data into a computer. A photograph of the animal may be captured by a digital camera and downloaded to a PC or obtained by a cell phone or a PDA. The present invention therefore encompasses numerous variations with regard to data input devices 36, including keyboard, mouse, bar-code scanner, PDA, hand-held computer, cell phone, EID tag reader, 2D matrix label reader, digital scale, magnetic card reader, digital camera and other conventional transducers, readers, scanners and apparatus for entering data.

Similarly, observed data 38 would include any data concerning the present state of the commodity or item being tracked. In the case of a steer 12a, this will include the time and location that the data is entered, a current picture of the animal, a prior picture, the owner, EID tag number, animal name, date of birth, gender, brand or tattoo, type, breed class, age, medical history, pedigree, weight, weighing date, size and color. Besides the foregoing objective data, certain data in the form of expert judgment or scoring may be entered in terms of a numerical score or other conventional classifying scheme along with the expert's identification. For a steer 12a, this scoring data may include: body conditioning, locomotion, hoof condition, lameness, longevity, udder, mouth, body frame and reproductive condition.

Recorded data on media 40 would include printed textural material, bar codes, 2D matrix labels, data recorded in magnetic media, such as CDs, magnetic sticks, strips and discs, EID tags, ROM chips, and any other conventional data recording media. Besides sharing the data about the commodity 12a with the server 22 and any subscribers 34 and/or other node systems 18b, 18c, node system 18a may also generate data output recorded on media 46, such as by overwriting an EID tag or printing a barcode or a 2D matrix label. In this manner, the data received by the data input devices 36, including observed data 38 and recorded data on media 40 may be selectively reproduced by the data output device(s) 45 on the data output recorded on media 46. For example, the birth date, breed and ownership data retrieved from an EID tag may be merged with the weight, health and feed history data keyed into a node system 18a computer 42 to produce a 2D matrix label that records the entirety of this data and is readable by other persons and systems who encounter the 2D matrix label in the future and who may or may not be participants in the data tracking and labeling system 10. That is, the 2D matrix label may be read by a stand-alone 2D matrix label reader system (that has been configured properly and given the appropriate access and permissions) independent from the data tracking and labeling system 10.

Given the foregoing, it can be appreciated that the system 10 enables the recording of data concerning a commodity, e.g., 12a as it is moved and processed to assume different states in different places over time. Having collected and stored the data in a database 26, the system 10 can readily generate reports concerning the commodity, e.g., 12a via conventional server and database processing software.

The tracking of a commodity, e.g., 12a is facilitated by utilizing a data field or fields representing time (month, day, year, hour, minute) and geographic location in terms of latitude, longitude, and elevation. Geographic location may also be specified by conventional addressing information (station, building number, entity name, street address, town, country, zip code). This time and location information establishes when and where a particular set of data pertaining to a commodity is entered. For example, a data record collected on steer 12a at farm 14a may be associated/tagged/identified by a location field specifying the location of the farm 14a and a field specifying the time when the data was entered. By associating data concerning the commodity with the place and time of its recordation, the system 10 can maintain a chronologically and geographically ordered, site-specific record of the history of the commodity 12a, 12b, 12c through its various stages of processing states in various environments 14a, 14b, 14c. The following is an exemplary field structure for recording geographic location:

| Country | State | Latitude | County | Longitude |
|---|---|---|---|---|
| USA | Florida | | Sarasota | |
| 011 | F28 | N272957 | 45S | W822771 |
| 3 digits | 3 digits | 7 digits | 3 digits | 7 digits |

The elevation above sea level can also be incorporated into the foregoing data structure to discern locations in the same building but on different floors. It should be noted that modern satellite GPS systems enable locations on the surface of the earth to be specified with precision, such that latitude and longitude coordinates can be used to locate a position to a high degree of precision and at a high resolution. In this manner, data captured on a steer in the field can be discerned from data collected hours later in a barn on the same farm via latitude and longitude coordinates.

FIG. 3 shows a 2D matrix label 50 which may be used with the tracking and labeling system 10. The 2D matrix label 50 may be generated by printing and read by a CCD camera. They have a high data density permitting a large volume of data to be stored in a small area. The foregoing features permit a single 2D matrix label 50 to store the entire history of a product 12a, 12b,12c. Accordingly, a package of meat 12c in a supermarket 14c may have a 2D matrix label 50 which contains all the data captured at the farm 14a, meat processing plant 14b and store 14c concerning the steer 12a and meat products 12b from which the package 14c was generated. As shall be described below, this is an attribute of the tracking and labeling system 10. By way of further example, a 2D matrix label 50 for olive oil tracked by the tracking and labeling system 10 may have the following format:
http://www.scoringsystem.com/sample vegetable.html
OLIVE OIL 1234567890 70670011101 OLIVE OIL 1.29 8.5 FL. OZ.
24
NA NA DAVINCI ITALY WORLD FINER FOODS INC.
UNK LOT L 253U0
   Labels using PDF417 symbols can be utilized for the present invention. Using the smallest recommended element size, PDF417 symbols can encode data at a density of up to 1,144 characters/inch². PDF-14 technology is known to those skilled in the art of labeling.

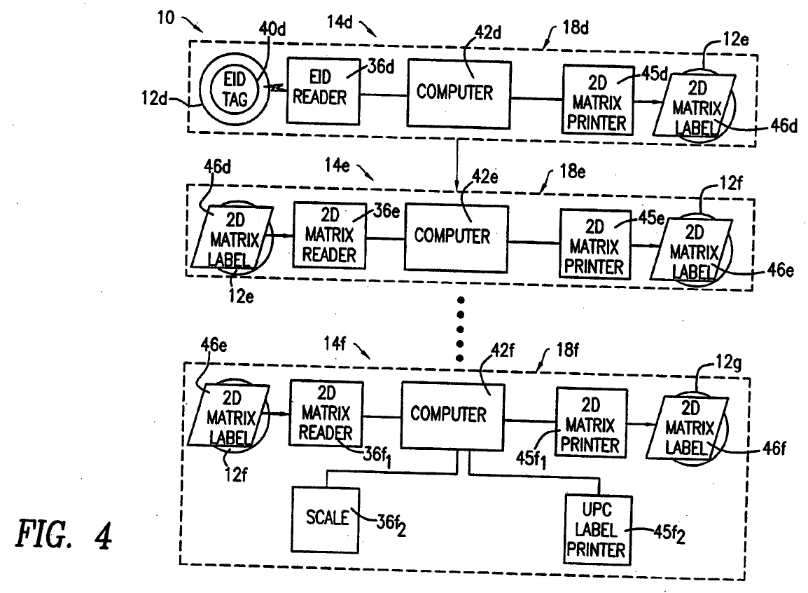

FIG. 4 shows a plurality of node systems 18d, 18f, 18g in an exemplary tracking and labeling system 10. Note that there is some overlap between the embodiment of the tracking and labeling system 10 shown in FIG. 4 and that previously described above in FIGS. 1-3. The numbering of common elements has been modified by changing the subscripts to indicate that FIG. 4 depicts an exemplary embodiment of the present invention that has some variations from that previously described. Node system 18d includes EID (electronic identification device) reader 36d for reading EID tag 40d on livestock (commodity graphically illustrated by circle 12d). The data retrieved from the EID reader 36d is received by computer 42d and posted to a network 20 for receipt and storage by server 22 (see FIG. 1). In addition to sharing the data retrieved from the tag 40d, the computer 42d induces a 2D matrix printer 45d to generate a 2D matrix label 46d, which is applied to commodity 12e (12d was changed to 12e to signify a change of state of the commodity at environment 14d. For simplicity, the commodity 12e retains its reference number after transfer to environment 14e, despite the fact that it is older and is in a new “post-shipping” state). The 2D matrix label 46d may contain the data retrieved from the EID tag 40d, as well as any data input by other data input devices (generically shown as element 36 in FIG. 2) present at environment 14d. The commodity 12d is then shipped to environment 14e. At environment 14e, data concerning the commodity 12e is retrieved from the 2D matrix label 46d that has been shipped with commodity 12e from environment 14d, e.g., the identification number, owner identification number, owner address, breed information, etc. taken from EID tag 40d by EID reader 36d, combined with observed data, such as the weight of the steer, its health condition, veterinary record, feed record, and age, which has been entered into the computer 42d by keyboard entry. All this information was encoded on 2D matrix label 46d, which was then applied to the commodity 12d, for example, by attaching the label to the steer or to the shipping container in which the steer is shipped to environment 14e.

Upon reaching environment 14e, the 2D matrix label 46d applied to or otherwise physically associated with commodity 12e is read by 2D matrix reader 36e at environment 14e. This information is processed by the computer 42e and is combined with other information specific to environment 14e. As before, the data collected at environment 14e may be conveyed to the server 22 via a network connection. In addition, the data present at environment 14e concerning commodity 12e may be combined with the data obtained from 2D matrix label 46d and encoded into a new 2D matrix label 46e printed out by a 2D matrix printer 45e. 2D matrix label 46e may then be applied to or otherwise physically associated with the commodity 12f in its then existing state at environment 14e. For example, if a steer 12e had been processed into sides of beef in environment 14e, which is a meat processing plant, then the commodity 12f, a side of beef, would receive a 2D matrix label 46e appropriate for conveying all the historical data for that side of beef, as well as new data recorded at environment 14e, such as, its weight, grade, inspector, identification number and the results of bacteriological testing, etc. Accordingly, 2D matrix label 46e that is applied to a side of beef 12f includes all the data pertaining to that commodity throughout its processing in environments 14d and 14e, and therefore reflects the complete dataset pertaining to that commodity up to that point in time. In addition, the server system 22 also has collected and stored the data pertaining to this commodity at each stage in its processing history. Alternatively, the 2D matrix label 46e (or other label, such as a written language label or barcode) can contain only a subset of the entire data set pertaining to the commodity. In one embodiment of the invention, the label has the internet address of the server 22 and at least one item of data that can serve to identify the commodity for retrieval of its historical data from the database 26.

The commodity 12f with 2D matrix label 46e is then transported to environment 14f, which may, for example, be a retail store, for further processing. Upon arrival, the commodity 12f and associated 2D matrix label is read by the 2D matrix reader 36f₁, and the associated data is fed into computer 42f. The computer 42f also receives data entered by other data input apparatus 36 (see FIG. 2) that would be applicable to a retail environment. For example, an inspector may examine each side of beef 12f that is received at the retail store 14f to ascertain that the meat has survived shipment in good condition and make note of its condition by entering that data into the computer 42f by means of a keyboard. The retail store 14f may also weigh the side of beef 12f and may spot-check it to test for contaminants. The processing of the commodity 12f at environment 14f may include processing of the side of beef 12f into consumer-sized cuts of meat 12g. Accordingly, the commodity 12f is converted into a different form 12g, which is weighed by scale 36f₂ and may also be graded by fat content, priced and otherwise categorized. This additional data may be entered into the computer 42f and shared with the server 22 by way of the network connection (see FIG. 1). In addition, a 2D matrix printer 45f, may produce a 2D matrix label 46f which expresses and contains some or all the historical data pertaining to the particular cuts of meat 129 to which it is applied. The computer may also generate other outputs such as UPC labels via a UPC label printer 45f₂.

Accordingly, a commodity, for example 12d, has been tracked and labeled by the tracking and labeling system 10 throughout its processing history, at various locations and in various states of processing, namely, 12d, 12e, 12f and 12g. All the data associated with the commodity and its various states is stored on the server 22 and is also stored and represented at every state by a label, for example, a 2D matrix label, which is physically associated with the commodity. As a result, there are two alternative means to access the history of the commodity, e.g., 12g at any stage in its processing life, namely, by reading the label, e.g. 46f, that is associated with the commodity 12g and/or by accessing the data that has been stored on the server system 22 (see FIG. 1). The tracking and labeling system 10 generates a data base 26 and labels, e.g., 46d, to retain tracking history by accumulating, recording, storing, and reporting object processing and other data for a wide variety of objects and scenarios. All these applications have the common need to identify members of an object class at each processing state, e.g. 12d, so that specific detailed information about the processing at that stage/environment 14d and earlier stages can be captured, combined, accessed and preserved. In so doing, what had begun as essentially “empty” record for the object 12d in its initial, unprocessed form becomes a completed historical record for each of the subsequent states and/or constituents of a compound object as it is processed and labeled at each environment 14d-14f, from start to finish.

To build the historical processing record in accordance with an embodiment of the present invention using 2D symbology, each processing environment 14e-14g reads the label, e.g., 14d on the input object, e.g., 12e to that environment, e.g. 14d, updates the label's record with new information, and creates a quantity of labels, e.g., 46e to identify each output object, e.g. 12f for transfer to the next environment 14f. The first record on each label, e.g., 46d may be a standard key data element common to all states 12d-12g and processing environments 14d-14f, corresponding to the URL (Internet web address) for the server 22. This enables an authorized user, e.g., 34 to access the online database 26 (by providing the proper login information) to read and update the database 26 in real time. In this manner, each label, e.g., 46d, need not contain the entire product history, but instead, may function as a key to access the history on the database 26. If the relevant data is encoded on the label, this data is available to a properly equipped user (who may be required to provide authorization) without an online connection, enabling the user to obtain updated information offline in read-only mode.

When the commodity has completed all processing, and the data record(s) is/are finalized in the database and in the form of a label on a product, this data can be archived for a specified storage period and accessed for reporting the history of the object, its origin and processing, as required. Reading the label on the finished product (online or offline) allows the user to retrieve and report the final source information and processing history on each individual item.

Data compaction and error correction techniques for several popular 2D symbologies satisfy the requirements of this application. The ability to control the parameters that determine size, shape, data content and reading characteristics of the label at each stage, as the object history is accumulated and capacity requirements change, makes this technology particularly suited to this application. This is especially important in view of: the range of severe environmental conditions; variety of object sources, sizes, and characteristics; number and type of processing stages; and other special conditions that make each application and object type unique. Data integrity and security are central features of this technology, arising from the mathematics and numerous programming options that are essential to 2D symbology.

Assuming that at least one and potentially numerous, records are entered into the database pertaining to the various states and processing that a commodity has undergone at least one and possibly numerous environments, the tracking of the commodity through its various states and locations during processing are readily obtainable as a written or viewable report presented on the screen of a user's computer. For example, if a person returns a cut of meat to the retail store in which they purchased it, complaining that it is in some manner unacceptable, such that it becomes of interest to determine exactly where the meat originated from, this task can be performed by the tracking and labeling system 10 of the present invention. In the first instance, the consumer preferably returns the meat in its original packaging, which would include the label prepared for the packaging by the present invention. The label would be readable by, e.g., a 2D matrix label reader to ascertain the data associated with the package of meat. This data can be read directly into a computer. Assuming that the retail store is a licensed user or otherwise has access to the tracking and labeling system 10, which is secured against unauthorized use and access by unauthorized users, the entire history of the meat can be retrieved from the database 26 by the server 22 using conventional database techniques, e.g., as are applied to process query requests to a relational database. For example, the tracking and labeling system 10 may maintain tables of all data transactions received from all specific geographic locations (corresponding to sites of specific processing functions and/or specific responsible parties in the production chain) These tables can be linked by source and destination fields, such that each record entry signifying a data entry transaction typically associated with a state change for the commodity (some form of processing) will indicate the geographic location and time when the entry is made, the geographic location from which the commodity was received and optionally, the target geographic location to which the commodity is to be sent. Given a particular reference record, e.g., that encoded on the questionable package of meat in the consumers hands, conventional database software can readily step back through all the linked records in the various relevant tables in the database corresponding to the various processing points to find all processing points that the commodity has experienced from the beginning. If the commodity is found to be defective in some way which indicates that like commodities that share some processing point could be a threat to health or welfare in some manner, then all commodities passing though that processing point can be identified and extracted from the database for any specified time period based upon a suitable query. The present location of all questionable commodities can then be ascertained, such that notification of the present possessors of the commodities can be undertaken and a product freeze or recall initiated with great speed. One can readily envision the same facilities employed to aid in tracing back a source of contamination for the purpose of diagnosis by means of identifying the various processing points that are the potential source of contamination and testing each of those source in turn.

While it is advantageous to have a labeled end product to initiate the querying process of the database 26 to track a specific product, it is not a necessary prerequisite. More specifically, the database 26 may be queried by an authorized user to search for any number and combination of criteria, e.g., “extract and display all sources of pork chops delivered to XYZ store in the 2^{nd} and 3^{rd} weeks of May, 2003”. It is also likely that as part of modern retail inventory control systems, the immediate source of the product can be identified, thus providing the starting information from which the database can be queried.

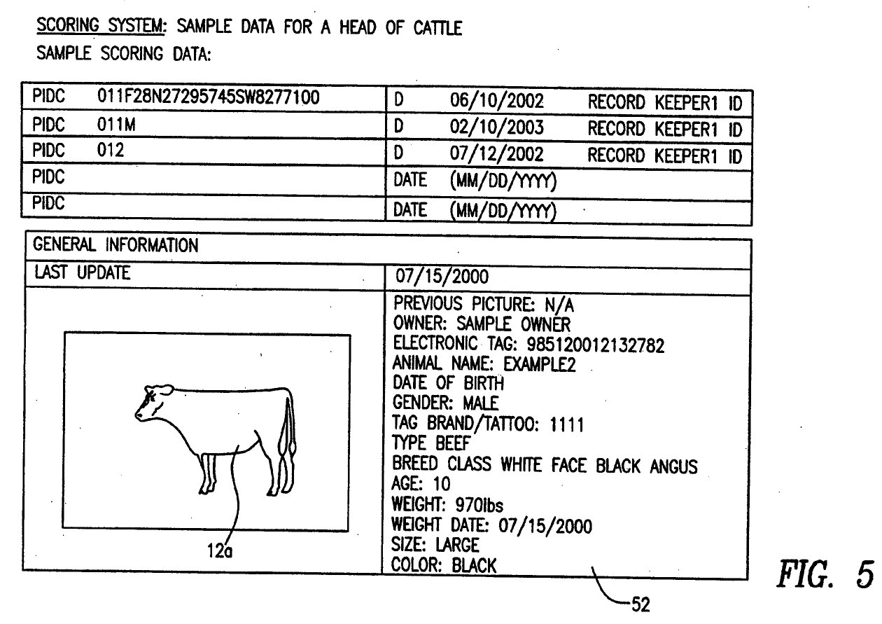

FIG. 5 shows sample data for a steer 12a as it would appear on a data entry/display screen 52 of a node computer 42 for entering and displaying data pertaining to a commodity by tracking and labeling system 10 of the present invention. “PDIC” refers to the site-specific geographic location code.

While the present invention has been explained above in terms of the processing of a steer, it may be used for tracking and labeling any product, such as, seeds, plants, bulbs, vegetables, fruits, vineyard crops, wines and beer hops. As noted above, the present invention lends itself to maintaining and sharing performance and quality scoring data pertaining to livestock, e.g., horses, dairy cows, beef cattle, goats, etc. As applied to wine, the following data would be included as being potentially relevant: photographs of the grapes, the wine, the vineyard, the region, the identification of the vineyard owner, location, the name of the wine, the identification of the harvester, a general description of the wine, alcohol content, whether it is drinkable by diabetics, sulfer, tannin and acid content, drinking temperature, price class, etc.

While a human being should never be considered a commodity, certain skills, such as athletic abilities, as exemplified by sports performance records, are sometimes viewed as commodities and could be recorded and tracked by the present invention. In the case of athletic (soccer) score/performance recording and tracking, the following data might be entered into the tracking and labeling system 10: name, age, hometown, citizenship, current club/team, height, weight, shoe size, years playing soccer, gender, age, marital status, children, player biography, current club/team, current field position, current jersey number, previous position, date started in this club/team, under contract, if yes, date of contract termination, previous club/team, previous profession or grade, technique, play on, number of goals (current team), number of goals (lifetime), goals on target, 100 meter time, and number of soccer awards.

While the foregoing exemplary uses of the present invention pertain to individual commodity units, such as a steer 12a, the present invention may also be utilized for manufactured, fabricated and compound products. For example, a manufacturer of frozen pizzas may utilize the tracking and labeling system 10 to enter the product information concerning all products (such as, flour, oil, tomato sauce and cheese) entering his factory that go into a batch of pizzas. The source-of-content information may be stored on the server 22 and may also be used to print a label which can be placed on the packaging of the finished pizza.

The present invention, therefore, provides a system for data collection, storage sharing, reporting and labeling. The system can handle any type of data concerning any type of tangible commodity or any other entity or intangible data fields throughout its entire history, providing a means for tracking individual and groups of tangible objects and intangible items (including data) and identifying all environments, processing and changes of state they have undergone.

1. A system for collecting and recording data on an item as the item experiences changes in state over time, comprising:
(A) first data input means for capturing a first set of data pertaining to a first state of the item in a first environment;
(B) second data input means for capturing a second set of data pertaining to a second state of the item in a second environment;
(C) data processing means for storing said first and second sets of data in a database and selectively accessing said first and second sets of data from said database; and
(D) communication means for communicating said first and second sets of data to said data processing means.

2. The system of claim 1, further comprising transportable data storage means for receiving and storing a third set of data, said transportable data storage means physically accompanying the item for a selected length of time.

3. The system of claim 2, further comprising a third data input means for reading said transportable data storage means and accessing said third set of data.

4. The system of claim 3, further comprising a first output means for writing a fourth set of data to said transportable data storage means.

5. The system of claim 3, wherein said first and second sets of data at least partially include data observed about the item in the first and second environments, respectively.

6. The system of claim 4, wherein said third set of data is captured by at least one of said first and second data input means.

7. The system of claim 4, wherein a portion of at least one of said first and second sets of data is included in said fourth set of data.

8. The system of claim 7, wherein a portion of said third set of data is included in said fourth set of data

9. The system of claim 4, wherein said first output means is selected from the group consisting of: a 2D matrix label printer, a barcode label printer, a text label printer, a magnetic card writer, a magnetic stick writer, a floppy disk writer, a and a CD writer.

10. The system of claim 3, wherein said third data input means is selected from the group consisting of: a 2D matrix label reader, a CCD camera, a barcode reader, a magnetic stripe reader, a magnetic card reader, an EID tag reader, a magnetic stick reader a CD reader, a floppy disk reader and an optical character reader.

11. The system of claim 2, wherein said transportable data storage means is selected from the group consisting of: a 2D matrix label, a barcode label, an EID tag, a magnetic stripe, a magnetic card, a magnetic stick, a ROM chip, a text label, a floppy disk and a CD disk.

12. The system of claim 1, wherein said first data input means is selected from the group consisting of: a Personal Digital Assistant (PDA), a cell phone, a digital camera, a handheld computer, a personal computer with keyboard, and a weighing scale.

13. The system of claim 1, wherein said data processing means includes a computer programmed with database management software.

14. The system of claim 1, wherein said communications means includes a network and said data processing means is connected to said network.

15. The system of claim 14, wherein said network is the internet.

16. A method for tracking an item as it changes state and environment over time, comprising the steps of:
(A) collecting and recording a first set of data pertaining to an item in a first state in a first environment;
(B) changing at least one of the first state and the first environment of the item to a second state and a second environment;
(C) collecting and recording a second set of data pertaining to the item;
(D) communicating the first and second sets of data to a data processing system;
(E) storing the first and second sets of data in a database of the data processing system; and
(F) selectively accessing at least a portion of the first and second data sets.

17. The method of claim 16, further including the step of reading a third set of data from first media physically accompanying the item.

18. The method of claim 17, further including the step of writing a fourth set of data on second media, said second media then being physically associated with the item to accompany the item for further changes in environment.

19. Then method of claim 16, wherein said step of collecting includes capturing observed data concerning the item when the item is in environment 1

20. The method of claim 18, wherein the step of collecting includes capturing observed data concerning the item when the item is in the first environment, the step of communicating includes transmitting the first set of data over the internet to the data processing system, the step of storing includes entering the first set of data into a database on the data processing system and the step of selectively accessing includes submitting a query via database management software to select data from the database in response to a user-defined criterion.

21. The method of claim 16, wherein said step of accessing is conducted in the course of identifying the source of a health threat associated with the item.

22. The method of claim 21, wherein the item is a food product.

23. The method of claim 16, wherein the item is a component of a composite item having additional compositional items and further comprising the steps of tracking the additional compositional items and the composite item by performing the steps (A) through (F) for each.

24. The method of claim 16, wherein the item is the performance record of an athlete.

25. An item tracking system for collecting and recording data on an item as the item experiences changes in state over time, comprising:
(A) a server computer with data processing capability and a database, said server computer connected to the internet;
(B) a plurality of geographically separated node systems connectable to the internet, each of said plurality of node systems capable of capturing data concerning the item at various times and states of the item and communicating the captured data to the server via the internet for storage in said database, said server computer capable of generating a history of said item from the data captured and sent to said server from said plurality of node systems.

26. The tracking system of claim 25, further including a label reader associated with at least a portion of said plurality of node systems, said label reader capable of reading labels physically associated with the item to obtain label data and communicating that label data to said server.

27. The tracking system of claim 26, further comprising a label printer, said label printer printing labels representative of data concerning the item and thereby permitting the item to be relabeled with data that reflects an up-to-data product history.

28. The tracking system of claim 27, wherein the type of label produced by said label printer is selected from the group consisting of: 2D matrix label, bar-code label and text label.

29. The tracking system of claim 27, wherein the label printed by said label printer includes the internet address of said server and identification data for identifying the item.

30. The tracking system of claim 25, wherein the captured data on the item is communicated to said server along with data indicative of the geographic location of the item and time.
